(19) United States
(12) Patent Application Publication
(10) Pub. No.: US 2025/0376016 A1
(43) Pub. Date: Dec. 11, 2025

(54) WATER DRAINAGE STRUCTURE OF VEHICLE MIDGATE

(71) Applicants: Hyundai Motor Company, Seoul (KR); Kia Corporation, Seoul (KR)

(72) Inventors: Jung-Ki Kim, Hwaseong-si (KR); Soo-Kyung Han, Hwaseong-si (KR); Min-Cheol Kim, Hwaseong-si (KR); Sun-Ki Choi, Hwaseong-si (KR)

(21) Appl. No.: 18/952,036

(22) Filed: Nov. 19, 2024

(30) Foreign Application Priority Data
Jun. 11, 2024 (KR) 10-2024-0075538

(51) Int. Cl. B60J 10/25; B60J 10/21; B60J 10/86

(52) U.S. Cl. CPC B60J 10/25; B60J 10/21; B60J 10/86; B60Y 2200/14

(57) ABSTRACT

A water drainage structure of a vehicle midgate for can be configured for preventing water from entering a cabin by draining downward water entering through the midgate installed between the cabin and a cargo compartment of a vehicle. A water drainage structure of a vehicle midgate can include a midgate that can be installed between a cabin and a cargo compartment of a vehicle and can fold into the cabin, a partition lower rear member that can be installed at the bottom of the midgate in the width direction of the vehicle, and a partition lower rear that can be connecting the top of the partition lower rear member with a floor panel. The partition lower rear member can guide the flow of water drained from the midgate and drain water from the partition lower rear member to the floor panel along the partition lower rear member.

### CROSS-REFERENCE TO RELATED APPLICATIONS

This application claims priority to Korean Patent Application No. 10-2024-0075538, filed on Jun. 11, 2024, which is incorporated herein by reference in its entirety.

### TECHNICAL FIELD

The present disclosure relates to a water drainage structure of a vehicle midgate.

### BACKGROUND

Vehicles like pickup trucks have a midgate between a cabin and a cargo compartment. The midgate is installed to fold into the cabin of the vehicle, thereby facilitating the loading of long cargo and increasing utilization.

In general, the other doors of the vehicle open outward, so a water drainage structure is applied thereto. In other words, when water such as rain or wash water attempts to enter the cabin through the door from the outside, a drainage hole formed at the bottom of the door facilitates the drainage of this water to the outside, thereby preventing water from entering the cabin.

However, when such a water drainage structure is used for the midgate, water from the outside enters the cabin through the gap between the midgate and the partition on which the midgate is installed.

### SUMMARY

Example embodiments of the present disclosure relate to a water drainage structure of a vehicle midgate that can prevent water from entering a cabin by draining downward the water entering through the midgate, which is installed between the cabin and a cargo compartment of a vehicle and folds toward the cabin.

Various embodiments of the present disclosure are directed to a water drainage structure of a vehicle midgate that can prevent water entering through the midgate from flowing into a cabin by draining the water outside, especially in vehicles like pickup trucks.

A water drainage structure of a vehicle midgate according to an embodiment of the present disclosure can include a midgate, which is installed between a cabin and a cargo compartment of a vehicle and folds into the cabin, a partition lower rear member installed at the bottom of the midgate in the width direction of the vehicle, and a partition lower rear connecting the top of the partition lower rear member with a floor panel. The partition lower rear member can guide the flow of water drained from the midgate and drain water from the partition lower rear member to the floor panel along the partition lower rear member.

The partition lower rear member can include a front portion, an upper inclined surface configured to extend from the top of the front portion toward the rear of the vehicle and can have a drainage hole formed to allow water drained from the midgate to pass through the partition lower rear member and drain out, and a lower inclined surface can be configured to extend from the bottom of the front portion toward the rear of the vehicle and drain water passed through the upper inclined surface to the floor panel.

The upper inclined surface can guide water entering through the midgate to flow toward the center in the width direction of the vehicle.

The upper inclined surface can be formed with a downward incline that decreases in height toward the center in the width direction of the vehicle.

The upper inclined surface can be formed with a downward incline toward the rear of the vehicle.

The lower inclined surface can be formed with a downward incline that decreases in height toward the center in the width direction of the vehicle.

The lower inclined surface can be formed with a downward incline toward the rear of the vehicle.

The partition lower rear member can include a drainage guide surface to restrict water entering through the midgate from moving in the width direction of the vehicle from the partition lower rear member.

The drainage guide surface can be formed within a predetermined distance from side end-side ends of the partition lower rear member, can be perpendicular to the ground, and can have a predetermined width in the longitudinal direction of the vehicle.

The drainage guide surface can be formed on an inner side of the vehicle at a connection portion where the partition lower rear member is connected with a partition lower side front.

The partition lower rear member can further include an upper fastening portion extending upward from a rear edge of the upper inclined surface and a lower fastening portion extending downward from a rear edge of the lower inclined surface, wherein the top of the upper fastening portion can be connected to the top of the partition lower rear, and the bottom of the lower fastening portion can be connected to the floor panel.

A partition lower front can be provided to connect the front portion of the partition lower rear member with the floor panel.

The partition lower rear can be formed with a drainage bead, which can protrude from the partition lower rear toward the rear of the vehicle, and the bottom of the drainage bead can be spaced apart from the partition lower rear member.

The drainage bead can be formed at intervals along the width direction of the vehicle.

With the water drainage structure of a vehicle midgate having the above configuration according to an embodiment of the present disclosure, water that attempts to enter the cabin from outside through the gap between the midgate and the partition can be guided along the partition to the bottom thereof, and then can be drained outside the vehicle through a drainage hole, thereby preventing water from entering the cabin through the midgate.

### BRIEF DESCRIPTION OF THE DRAWINGS

FIG. 1 is a schematic view of a vehicle utilizing a water drainage structure of a vehicle midgate according to an embodiment of the present disclosure.

FIG. 2 is a front view of an area where a partition, a glass, and a midgate are installed in a vehicle utilizing a water drainage structure of a vehicle midgate according to an embodiment of the present disclosure.

FIG. 3 is a sectional view taken along line A-A of FIG. 2.

FIG. 4 is a sectional view taken along line B-B of FIG. 2.

FIG. 5A is a perspective view showing a state in which a drainage hole is formed in a partition lower rear member in a water drainage structure of a vehicle midgate according to an embodiment of the present disclosure.

FIG. 5B is a perspective view showing a state in which water flows along an upper inclined surface of a partition lower rear member in a water drainage structure of a vehicle midgate according to an embodiment of the present disclosure.

FIG. 5C is a perspective view showing a state in which water flows along a lower inclined surface of a partition lower rear member in a water drainage structure of a vehicle midgate according to an embodiment of the present disclosure.

FIG. 6A is a cutaway perspective view showing a state in which water flows as viewed from a cabin in accordance with a water drainage structure of a vehicle midgate according to an embodiment of the present disclosure.

FIG. 6B is a cutaway perspective view showing a state in which water flows as viewed from a cargo compartment in accordance with a water drainage structure of a vehicle midgate according to an embodiment of the present disclosure.

FIG. 6C is a perspective view showing a state in which a drainage bead is formed on a partition lower rear in accordance with a water drainage structure of a vehicle midgate according to an embodiment of the present disclosure.

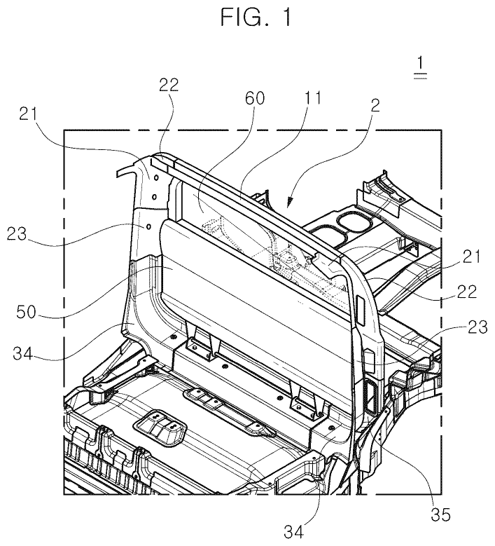

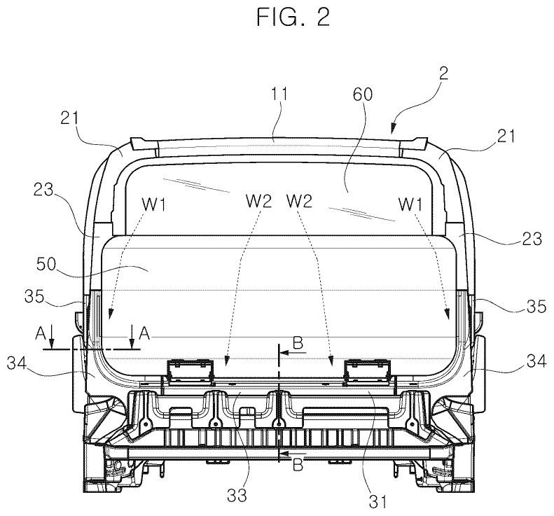

### DETAILED DESCRIPTION OF ILLUSTRATIVE EMBODIMENTS

A water drainage structure of a vehicle midgate according to an example embodiment of the present disclosure will be described hereinafter in detail with reference to the accompanying drawings.

A water drainage structure of a vehicle midgate according to an embodiment of the present disclosure can include a midgate 50, which can be installed between a cabin and a cargo compartment of a vehicle 1 and can fold into the cabin, a partition lower rear member 33 that can be installed at the bottom of the midgate 50 in the width direction of the vehicle 1, a partition lower rear 32 that can be connecting the top of the partition lower rear member 33 with a floor panel 40. The partition lower rear member 33 can guide the flow of water drained from the midgate 50 and drain water from the partition lower rear member 33 to the floor panel 40 along the partition lower rear member 33.

The vehicle 1, such as a pickup truck, has the cabin and the cargo compartment separated by a partition 2 installed at the rear of the cabin. In the partition 2, a rear glass 60 for observing the rear and the foldable midgate 50 can be installed. The partition 2 can support the perimeter of the rear glass 60 and the midgate 50.

The midgate 50 can be installed to fold into the cabin, allowing the midgate 50 to be opened to load long cargo, thereby increasing utilization thereof.

The partition 2 can include a partition upper extending from the top, partition sides extending downward from both ends of the partition upper, and a partition lower installed on the floor panel 40 of the vehicle 1 and connected with the bottom of the partition sides.

The partition upper can be installed at the top of the partition 2 in the width direction of the vehicle 1. The partition upper can be installed in the width direction of the vehicle 1 and include a partition upper front 11 and a partition upper rear that can be connected to each other in the longitudinal direction of the vehicle 1. The partition upper can be connected to the underside of a roof of the vehicle 1.

The partition sides can be installed on both side end-side ends of the partition 2. The partition sides can be connected to inner surfaces of a rear pillar of the vehicle 1. The partition sides can support sides of the rear glass 60 and sides of the midgate 50. The partition sides can include a rear pillar upper front 21 and a rear pillar upper rear 22, each arranged in the longitudinal direction of the vehicle 1 at the top of the partition sides, and a rear pillar center 23 connected to the bottom of the rear pillar upper front 21 and the rear pillar upper rear 22.

The partition lower can be connected to the lower part of the partition sides and the floor panel 40. The partition lower can form an annular structure that ensures rigidity at the rear of the cabin together with the partition upper and the partition sides.

The partition lower can be formed in the width direction of the vehicle 1 and include a partition lower front 31, a partition lower rear 32, and a partition lower rear member 33, which can be arranged on the floor panel 40 in the longitudinal direction of the vehicle 1. The partition lower front 31, the partition lower rear 32, and the partition lower rear member 33 can support the midgate 50 from below the midgate 50 and drain water drained from the midgate 50 to the floor panel 40. The side end-side ends of the partition lower front 31, partition lower rear 32, and partition lower rear member 33 can be provided with a partition lower side front 34 and a partition lower side rear 35, which can be connected to the bottom of the partition side.

In an embodiment, the partition lower can guide water drained from the midgate 50 to flow to the floor panel 40 of the cargo compartment. When water such as rainwater or wash water is sprayed onto the rear glass 60 and the midgate 50 during rain or car washing, most of the water can flow downward along the rear surface of the rear glass 60 and the rear surface of the midgate 50. However, some water can flow downward through side ends of the midgate 50 (see arrow W1), or flow downward through the inside of the midgate 50 (see arrow W2). By guiding water to flow downward through the midgate 50 and allowing the water to drain to the floor panel 40 on the cargo compartment side, water can be prevented from entering the cabin.

The partition lower can include the partition lower front 31, the partition lower rear 32, and the partition lower rear member 33 arranged on the floor panel 40 along the longitudinal direction of the vehicle 1, which can be fastened to the floor panel 40, forming the lower structure of the partition 2 and supporting the underside of the midgate 50.

The partition lower front 31 and the partition lower rear 32 can be respectively fastened to the front and rear of the partition lower rear member 33. The bottom of the partition lower front 31 can be fastened to the floor panel 40, and the top can be fastened to the partition lower rear member 33. The top and bottom of the partition lower rear 32 can be respectively connected to the top and bottom of the partition lower rear member 33.

By fastening the partition lower front 31, the partition lower rear 32, and the partition lower rear member 33 to each other, rigidity may be ensured at the lower part of the partition 2.

In particular, the partition lower rear member 33 and a drainage guide surface 33a can be formed at the partition lower rear member 33 and can guide water drained from the midgate 50 to flow downward.

The partition lower rear member 33 can be formed with the drainage guide surface 33a that can guide water entering through the side end of the midgate 50 to flow downward rather than in the width direction of the vehicle 1, for example, toward the rear pillar.

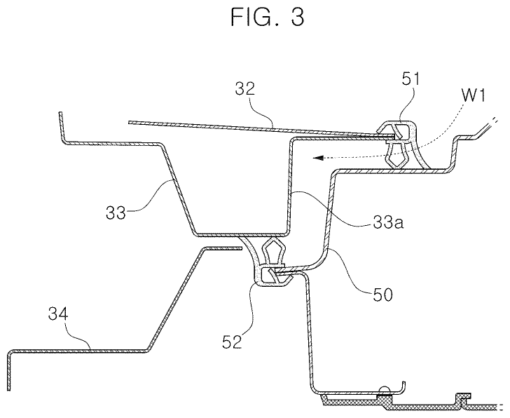

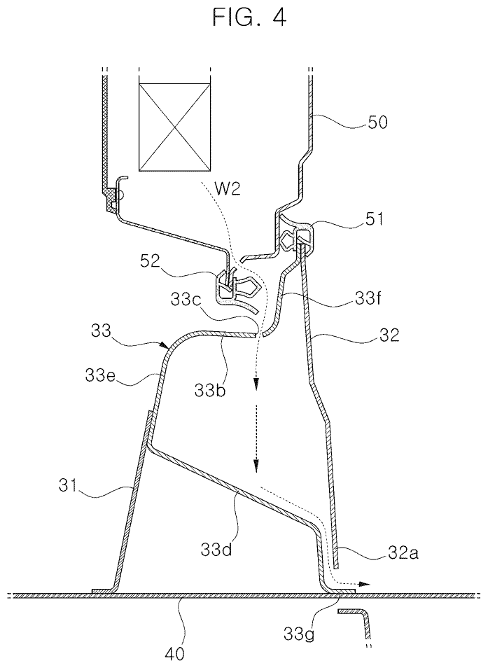

The drainage guide surface 33a can be formed within a predetermined distance from side ends of the partition lower rear member 33, can be perpendicular to the ground, and can have a predetermined width in the longitudinal direction of the vehicle 1. In FIG. 3, the vertical direction of the drawing is the width of the drainage guide surface 33a. The drainage guide surface 33a can ensure that water entering through the side end of the midgate 50 no longer flows in the width direction of the vehicle 1 but flows downward along the drainage guide surface 33a.

The partition lower rear member 33 can be connected with the partition lower side front 34 that protrudes forward from the vehicle 1 at a portion adjacent to the side end of the partition lower rear member 33. The drainage guide surface 33a can be formed in the width direction of the vehicle 1, perpendicular to a connection portion where the partition lower rear member 33 is connected with the partition lower side front 34. The drainage guide surface 33a can be formed on an inner side of the vehicle 1 at the connection portion where the partition lower rear member 33 is connected with the partition lower side front 34.

An upper inclined surface 33b, a drainage hole 33c, and a lower inclined surface 33d can be formed on the partition lower rear member 33 to guide water drained from the midgate 50 to flow to the floor panel 40.

The upper inclined surface 33b can extend from the top of a front portion 33e of the partition lower rear member 33, formed on the front of the vehicle 1, toward the rear of the vehicle 1. The lower inclined surface 33d can extend from the bottom of the front portion 33e toward the rear of the vehicle 1.

The upper inclined surface 33b can have the drainage hole 33c formed to allow water drained from the midgate 50 to pass through the partition lower rear member 33. Water can flow downward through the drainage hole 33c from the upper inclined surface 33b.

The lower inclined surface 33d can guide water drained through the drainage hole 33c from the upper inclined surface 33b to flow to the floor panel 40.

The upper inclined surface 33b can be formed with an incline to allow water drained from the midgate 50 to flow along a set path on the upper inclined surface 33b.

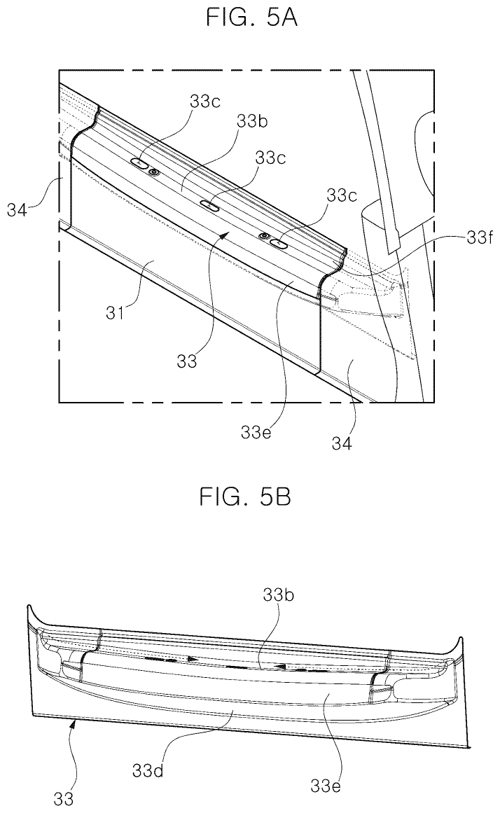

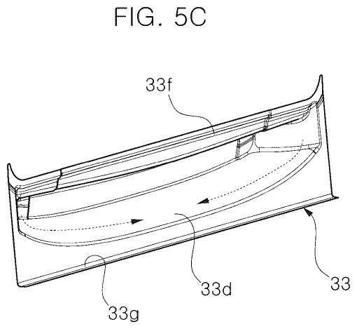

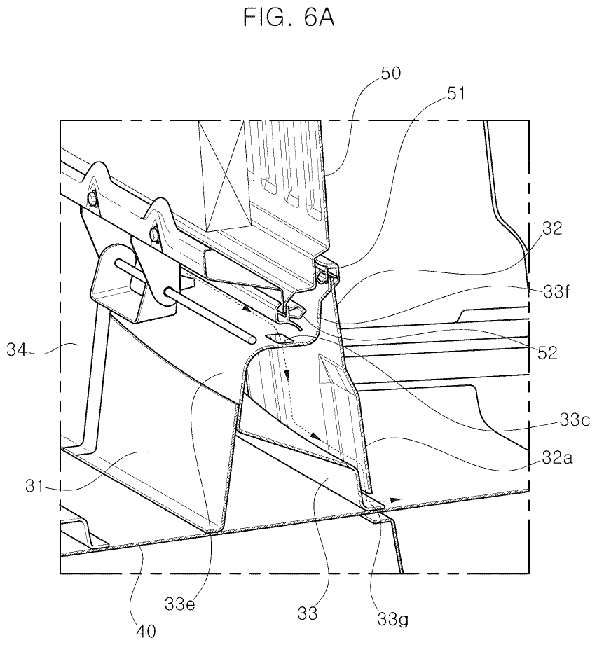

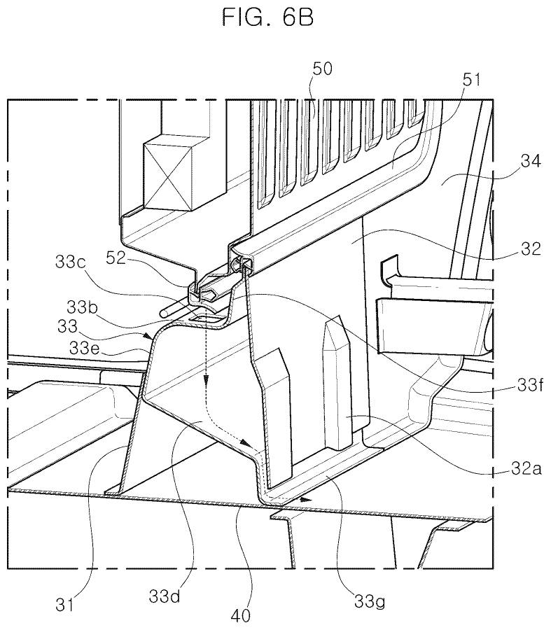

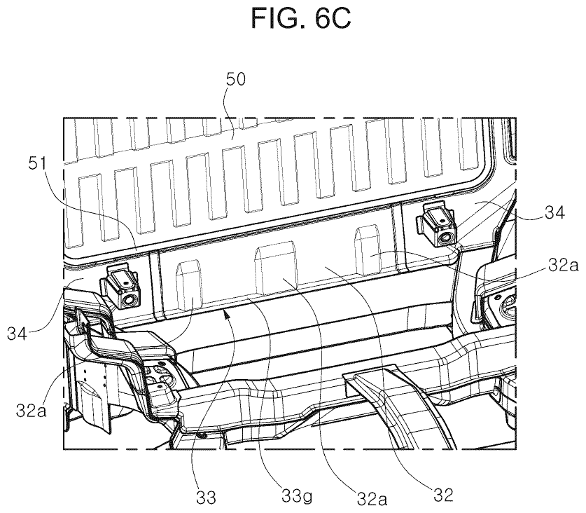

In other words, the upper inclined surface 33b can guide water entering through the midgate 50 to flow toward the center in the width direction of the vehicle 1. To achieve this, the upper inclined surface 33b can be formed with a downward incline that decreases in height toward the center in the width direction of the vehicle 1 (see FIG. 5b). Accordingly, water on the upper inclined surface 33b can flow toward the center in the width direction of the upper inclined surface 33b. Because multiple drainage holes 33c can be formed at intervals along the width direction of the vehicle 1 on the upper inclined surface 33b, water moving toward the center of the upper inclined surface 33b can be drained through the drainage holes 33c to the lower inclined surface 33d.

In particular, the upper inclined surface 33b can be formed with a downward incline that decreases in height toward the rear of the vehicle 1. Because the upper inclined surface 33b can be formed with a downward incline toward the rear of the vehicle 1, water can be prevented from flowing from the upper inclined surface 33b to the cabin along the front portion 33e.

The lower inclined surface 33d can be also formed with a downward incline toward the rear of the vehicle 1, which can guide water drained to the lower inclined surface 33d to flow to the floor panel 40 (see FIG. 5c). Preferably, the lower inclined surface 33d can be formed with a larger angle of inclination than the upper inclined surface 33b. The lower inclined surface 33d may also be formed with a downward incline that decreases in height toward the center in the width direction of the vehicle 1.

The partition lower front 31 can be fastened to the front portion 33e of the partition lower rear member 33. The bottom of the partition lower front 31 can be fastened to the floor panel 40 on the cabin side, and the top can be fastened to the front portion 33e of the partition lower rear member 33.

The partition lower rear 32 can be fastened to the rear of the partition lower rear member 33. The partition lower rear member 33 can include an upper fastening portion 33f extending upward from a rear edge of the upper inclined surface 33b, and a lower fastening portion 33g extending downward from a rear edge of the lower inclined surface 33d. The top and bottom of the partition lower rear 32 can be joined to the upper fastening portion 33f and the lower fastening portion 33g, respectively, such that the partition lower rear member 33 and the partition lower rear 32 can be fastened together.

The partition lower rear 32 can be formed with a drainage bead 32a at the lower part, which can protrude from the partition lower rear 32 toward the rear of the vehicle 1. The bottom of the drainage bead 32a can be spaced apart from the partition lower rear member 33. When the bottom of the partition lower rear member 33 and the bottom of the partition lower rear 32 are fastened entirely along the width direction of the vehicle 1, water flowing along the lower inclined surface 33d may not be drained to the outside. Therefore, the drainage bead 32a can guide water flowing along the lower inclined surface 33d to be drained to the floor panel 40 on the cargo compartment side.

Preferably, a plurality of drainage beads 32a can be formed at intervals along the width direction of the vehicle 1.

The process of water drainage in accordance with a water drainage structure of a vehicle midgate having the above configuration according to an embodiment of the present disclosure can be as follows.

When water is sprayed onto the rear glass 60 and the midgate 50 during rain or car washing, most of the water can flow along the rear surface of the rear glass 60 and the rear surface of the midgate 50 to the cargo compartment and can be drained to the ground. The midgate 50 can be manufactured by processing a metal panel, and weatherstrips 51 and 52 can be installed respectively around the perimeter of the midgate 50 and at a joining portion of the partition lower rear 32 and the partition lower rear member 33, so that most of the water can flow along the rear surface of the rear glass 60 and the rear surface of the midgate 50.

However, some water can enter through the gap between the side end of the midgate 50 and the partition 2 via the side end of the midgate 50 (see arrow W1). Such water can flow downward along the drainage guide surface 33a and flow toward side ends of the upper inclined surface 33b.

Water entering the inside of the midgate 50 can be drained to the upper inclined surface 33b through the drainage hole 33c formed at the bottom of the midgate 50 (see arrow W2).

On the upper inclined surface 33b, water can flow toward the center of the upper inclined surface 33b and then flow toward the rear of the vehicle 1. Because the upper inclined surface 33b can be formed with a downward incline toward the center and rear of the vehicle 1, water can flow along this incline.

The water flowing along the upper inclined surface 33b can be drained through the drainage hole 33c to the lower inclined surface 33d, and then flow along the lower inclined surface 33d toward the rear of the vehicle 1.

The water flowing along the lower inclined surface 33d can be drained through the drainage bead 32a to the floor panel 40 on the cargo compartment side and then to the ground.

In this way, even if water enters through the perimeter or inside of the midgate 50, the flow of water can be guided toward the floor panel 40, not into the cabin, thereby preventing water from entering the cabin.

What is claimed is:

1. A water drainage structure of a vehicle midgate system comprising:
a midgate installed between a cabin and a cargo compartment of a vehicle and configured to fold into the cabin;
a partition lower rear member installed at a midgate bottom of the midgate in a width direction of the vehicle; and
a partition lower rear connecting a partition-lower-rear-member top of the partition lower rear member with a floor panel, wherein the partition lower rear member is configured to guide a flow of water drained from the midgate and drain water from the partition lower rear member to the floor panel along the partition lower rear member.

2. The structure of claim 1, wherein the partition lower rear member comprises:
a front portion;
an upper inclined surface configured to extend from a front-portion top of the front portion toward a rear of the vehicle and have a drainage hole configured to allow water drained from the midgate to pass through the partition lower rear member and drain out; and
a lower inclined surface configured to extend from a front-portion bottom of the front portion toward the rear of the vehicle and drain water passed through the upper inclined surface to the floor panel.

3. The structure of claim 2, wherein the upper inclined surface is configured to guide water entering through the midgate to flow toward a center in the width direction of the vehicle.

4. The structure of claim 3, wherein the upper inclined surface is configured with a downward incline that decreases in height toward the center in the width direction of the vehicle.

5. The structure of claim 2, wherein the upper inclined surface is configured with a downward incline toward the rear of the vehicle.

6. The structure of claim 2, wherein the lower inclined surface is configured with a downward incline that decreases in height toward a center in the width direction of the vehicle.

7. The structure of claim 2, wherein the lower inclined surface is configured with a downward incline toward the rear of the vehicle.

8. The structure of claim 1, wherein the partition lower rear member includes a drainage guide surface configured to restrict water entering through the midgate from moving in the width direction of the vehicle from the partition lower rear member.

9. The structure of claim 8, wherein the drainage guide surface is configured within a first distance from side ends of the partition lower rear member, is perpendicular to a ground, and has a first width in a longitudinal direction of the vehicle.

10. The structure of claim 9, wherein the drainage guide surface is disposed on an inner side of the vehicle at a connection portion where the partition lower rear member is connected with a partition lower side front.

11. The structure of claim 2, wherein the partition lower rear member further comprises:
an upper fastening portion extending upward from a upper-inclined-surface rear edge of the upper inclined surface; and
a lower fastening portion extending downward from a lower-inclined-surface rear edge of the lower inclined surface, wherein an upper-fastening-portion top of the upper fastening portion is connected to a partition-lower-rear top of the partition lower rear, and wherein a lower-fastening-portion bottom of the lower fastening portion is connected to the floor panel.

12. The structure of claim 2, wherein a partition lower front is configured to connect the front portion of the partition lower rear member with the floor panel.

13. The structure of claim 1, wherein the partition lower rear is configured with a drainage bead that protrudes from the partition lower rear toward a rear of the vehicle, and wherein a drainage-bead bottom of the drainage bead is spaced apart from the partition lower rear member.

14. The structure of claim 13, wherein the drainage bead is configured at intervals along the width direction of the vehicle.

15. A water drainage structure of a vehicle midgate system comprising:
a midgate installed between a cabin and a cargo compartment of a vehicle and configured to fold into the cabin;
a partition lower rear member installed at a midgate bottom of the midgate in a width direction of the vehicle, wherein the partition lower rear member comprises:
a front portion,
an upper inclined surface configured to extend from a front-portion top of the front portion toward a rear of the vehicle and have a drainage hole configured to allow water drained from the midgate to pass through the partition lower rear member and drain out, wherein the upper inclined surface is configured to guide water entering through the midgate to flow toward a center in the width direction of the vehicle, wherein the upper inclined surface is configured with a first downward incline that decreases in height toward the center in the width direction of the vehicle, and wherein the upper inclined surface is configured with a second downward incline toward the rear of the vehicle, and
a lower inclined surface configured to extend from a front-portion bottom of the front portion toward the rear of the vehicle and drain water passed through the upper inclined surface to a floor panel, wherein the lower inclined surface is configured with a third downward incline that decreases in height toward the center in the width direction of the vehicle, and wherein the lower inclined surface is configured with a fourth downward incline toward the rear of the vehicle; and
a partition lower rear connecting a partition-lower-rear-member top of the partition lower rear member with a floor panel, wherein the partition lower rear member is configured to guide a flow of water drained from the midgate and drain water from the partition lower rear member to the floor panel along the partition lower rear member.

16. The structure of claim 15, wherein the partition lower rear member includes a drainage guide surface configured to restrict water entering through the midgate from moving in the width direction of the vehicle from the partition lower rear member.

17. The structure of claim 16, wherein the drainage guide surface is configured within a first distance from side ends of the partition lower rear member, is perpendicular to a ground, and has a first width in a longitudinal direction of the vehicle, and wherein the drainage guide surface is disposed on an inner side of the vehicle at a connection portion where the partition lower rear member is connected with a partition lower side front.

18. The structure of claim 15, wherein the partition lower rear member further comprises:
an upper fastening portion extending upward from a upper-inclined-surface rear edge of the upper inclined surface; and
a lower fastening portion extending downward from a lower-inclined-surface rear edge of the lower inclined surface, wherein an upper-fastening-portion top of the upper fastening portion is connected to a partition-lower-rear top of the partition lower rear, and wherein a lower-fastening-portion bottom of the lower fastening portion is connected to the floor panel.

19. The structure of claim 15, wherein a partition lower front is configured to connect the front portion of the partition lower rear member with the floor panel.

20. The structure of claim 15, wherein the partition lower rear is configured with a drainage bead that protrudes from the partition lower rear toward a rear of the vehicle, and wherein a drainage-bead bottom of the drainage bead is spaced apart from the partition lower rear member, wherein the drainage bead is configured at intervals along the width direction of the vehicle.
